(19) United States
(12) Patent Application Publication
(10) Pub. No.: US 2007/0256029 A1
(43) Pub. Date: Nov. 1, 2007

(54) Systems And Methods For Interfacing A User With A Touch-Screen

(75) Inventor: Ian Andrew Maxwell, New South Wales (AU)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: RPO Pty Llimited, Acton (AU)

(21) Appl. No.: 11/741,270

(22) Filed: Apr. 27, 2007

(30) Foreign Application Priority Data
May 1, 2006 (AU) 2006902241

(51) Int. Cl. G06F 3/048; G06F 3/041

(52) U.S. Cl. 715/834; 345/173

(57) ABSTRACT

Described herein are systems and methods for interfacing a user with a touch-screen. In overview, some embodiments provide for an array of conventional numerical keys to be graphically represented as a primary menu on a touch-screen of a cellular phone or PDA. The graphically represented keys arranged as sectors or annular sectors in a contiguous array around a central origin. To provide text-based input (for example in the process of authoring a text-message or email), a user touch-selects one of the keys, and is provided with a secondary menu for allowing selection of a particular alphanumeric character associated with the selected numerical key. This association is optionally based on a protocol such as ETSI ETS 300 640 or ITU-T Recommendation E.161. In some embodiments the secondary menu, or a similar tertiary menu, is used to provide additional predictive text functionality.

### FIELD OF THE INVENTION

The present invention relates to interfacing a user with an electronic device, and more particularly to systems and methods for interfacing a user with a touch-screen. Embodiments of the invention have been particularly developed for providing a touch-actuated interface for entering alphanumeric information on a portable electronic device, and the present disclosure is primarily focused accordingly. Although the invention is described hereinafter with particular reference to such applications, it will be appreciated that the invention is applicable in broader contexts.

### BACKGROUND

Any discussion of the prior art throughout the specification should in no way be considered as an admission that such prior art is widely known or forms part of common general knowledge in the field.

Various portable electronic devices provide functionalities that rely on text-based input. Common examples include text-message and email authoring on cellular telephones or Personal Digital Assistants (PDAs). Given the inherently small size of portable electronic devices, providing a suitable interface for accepting text-based input presents significant practical challenges. Two approaches have been widely adopted:

The provision of a QWERTY style keypad. This is difficult to effectively implement given the small size of devices and, where implemented, is often relatively difficult to use given the small size of keys.
The provision of software for allowing text-based input from a traditional 12-key telephone keypad, such as a keypad based on an independent standard where characters of the alphabet are assigned across numerical keys (such as ETSI ETS 300 640 or ITU-T Recommendation E. 161). This approach has increased in popularity due to predictive text protocols such as “T9”.

Consumer-preferences are affecting the evolution of portable electronic device design. Generally speaking, the market is simultaneously calling for smaller devices and larger screens. As a result, some manufacturers are replacing physical keypads with virtual keypads provided by touch-screens. However, given the nature of touch-screens, using the devices (particular by single-handed operation) is typically clumsy and difficult, particularly for providing text-based input.

It follows that there is a need in the art for improved systems and methods for interfacing a user with a touch-screen.

### SUMMARY

One aspect of the present invention provides a method for interfacing a user with a touch-screen, the method including the steps of:
(a) displaying on the touch-screen a representation of a substantially circular primary menu, the primary menu including a plurality of primary input regions arranged as sectors or annular sectors in a contiguous array, each primary input region being associated with a respective primary command, each primary input region displaying a representation indicative of its respective primary command;
(b) being responsive to a touch-selection of one of the primary input regions for identifying one or more secondary commands related to the primary command associated with the touch-selected primary input region;
(c) displaying on the touch-screen a representation of a secondary menu, the secondary menu radially extending substantially as an annular sector from the periphery of the primary menu substantially adjacent the touch-selected primary input region, the secondary menu including one or more secondary input regions, the one or more secondary input regions being respectively associated with the one or more secondary commands, each secondary input region displaying a representation indicative of its respective secondary command.

In one embodiment, for at least one primary input region, the representation is indicative of a plurality of distinct alphanumeric characters.

In one embodiment, for the at least one primary input region, the associated primary command is related to a plurality of secondary commands respectively corresponding to at least one of the distinct alphanumeric characters.

In one embodiment the relationship between primary and secondary commands is affected by the operation of a predictive text protocol, such that for the at least one primary input region, the associated primary command is relatable to a plurality of secondary commands respectively corresponding to predicted words.

In one embodiment the secondary menu shares a common origin with the primary menu.

In one embodiment the secondary menu has an angular divergence of between 50% and 200% of an angular divergence of the touch-selected primary input region.

In one embodiment the secondary menu has an angular divergence of between 100% and 150% of an angular divergence of the touch-selected primary input region.

In one embodiment the secondary menu has an angular divergence approximately equal to an angular divergence of the touch-selected primary input region.

In one embodiment, upon the secondary menu being displayed, the on-screen positioning of the primary and secondary menus varies.

In one embodiment the variation includes movement substantially along a vector defined by a central radius of the touch-selected primary input region having a direction towards an origin of the primary menu.

In one embodiment, upon the secondary menu being displayed, the on-screen scaling of the primary and secondary menus varies.

In one embodiment the primary input regions correspond to keys on a twelve-key telephone keypad.

One embodiment provides a method including the further steps of:
(d) being responsive to a touch-selection of one of the secondary input regions for inputting a character, symbol or word represented by that secondary input region;
(e) following step (d), closing the secondary menu.

One embodiment provides a method including the further steps of:
(f) being responsive to a touch-selection of one of the secondary input regions for identifying one or more tertiary commands related to the secondary command associated with the touch-selected secondary input region;
(g) displaying on the screen a representation of a tertiary menu, the tertiary menu radially extending substantially as an annular sector from the periphery of the secondary menu substantially adjacent the touch-selected secondary input region, the tertiary menu including one or more tertiary input regions, the one or more tertiary input regions being respectively associated with the one or more tertiary commands, each tertiary input region displaying a representation indicative of its respective tertiary command.

One embodiment provides a method including the steps of:
(h) being responsive to a touch-selection of one of the tertiary input regions for inputting a character, symbol or word represented by that tertiary input region;
(i) following step (h), closing the tertiary and secondary menus.

One embodiment provides a method including the steps of:
(j) being responsive to touch selection of a primary input region for identifying one or more predicted words on the basis of a predictive text protocol;
(k) providing in the secondary menu one or more secondary input regions each having an associated secondary command indicative of one of the predicted words, and displaying a representation indicative of that predicted word.

One embodiment provides a method including the steps of:
(l) being responsive to a touch-selection of one of the secondary input regions having an associated secondary command indicative of a predicted word for inputting that predicted word;
(m) following step (l), closing the secondary menu.

One embodiment provides a method including the steps of:
(n) being responsive to touch selection of a primary input region for identifying one or more predicted words on the basis of a predictive text protocol;
(o) displaying on the screen a representation of a tertiary menu, the tertiary menu radially extending substantially as an annular sector from the periphery of the secondary menu displayed at step (c), the tertiary menu including one or more tertiary input regions, the one or more tertiary input regions being respectively associated with one or more tertiary commands each respectively indicative of a predicted word, each tertiary input region displaying a representation indicative of its respective predicted word.

One embodiment provides a method including the steps of:
(p) being responsive to a touch-selection of one of the tertiary input regions having an associated tertiary command indicative of a predicted word for inputting that predicted word;
(q) following step (p), closing the tertiary and secondary menus.

A second aspect of the invention provides a method for interfacing a user with a touch-screen, the method including the steps of:
(a) displaying on the touch-screen a representation of a substantially circular primary menu, the primary menu including a plurality of primary input regions arranged as sectors or annular sectors in a contiguous array, the primary input regions including a set of primary input regions that correspond to one or more keys on a 12-key telephone keypad;
(b) being responsive to a touch-selection of one of the primary input regions for identifying one or more characters related to the touch-selected primary input region;
(c) displaying on the touch-screen a representation of a secondary menu, the secondary menu radially extending substantially as an annular sector from the periphery of the primary menu substantially adjacent the touch-selected primary input region, the secondary menu including one or more secondary input regions, the one or more secondary input regions corresponding to the one or more characters related to the touch-selected primary input region.

One embodiment provides a method including the steps of:
(d) being responsive to a touch-selection of one of the secondary input regions for inputting a character, symbol or word represented by that secondary input region;
(e) following step (d), closing the secondary menu.

One embodiment provides a method wherein the primary input regions are defined by the set of primary input regions that corresponds to the keys on a 12-key telephone keypad.

A third aspect of the invention provides a computer-readable carrier medium carrying a set of instructions that when executed by one or more processors cause the one or more processors to carry out a method according to the first or second aspect.

A fourth aspect of the invention provides a device including:
a touch-screen; and
a processor coupled to the touch-screen for carrying out a method according to the first or second aspect.

A fifth aspect of the invention provides a method for interfacing a user with a touch-screen, the method including the steps of:
(a) displaying on the touch-screen a representation of a substantially circular primary menu, the primary menu including a plurality of primary input regions arranged as sectors or annular sectors in a contiguous array, the primary input regions including a set of primary input regions that correspond to keys on a 12-key telephone keypad;
(b) being responsive to a touch-selection of one of the primary input regions for identifying one or more characters related to the touch-selected primary input region;
(c) providing a data packet indicative of the one or more characters to a predictive text module for:
   i. in the case that the data packet defines the commencement of a word, identifying none or more predicted words formable from the one or more characters of the data packet;
   ii. in the case that the data packet defines a portion of a previously commenced word defined by one or more preceding data packets, the preceding data packets each being indicative of a respective one of more characters, identifying none or more predicted words formable from the one or more characters of the data packet in combination with the respective one or more characters of the one or more preceding data packets;
(d) allowing a user to select between the none or more identified predicted words or touch-select another of the primary input regions;
(e) being responsive to a user-selection of one of the predicted words for providing an instruction to input the selected predicted word.

Reference throughout this specification to “one embodiment” or “an embodiment” or “some embodiments” means that a particular feature, structure or characteristic described in connection with the embodiment is included in at least one embodiment of the present invention. Thus, appearances of the phrases “in one embodiment” or “in an embodiment” or “in some embodiments” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

### BRIEF DESCRIPTION OF THE DRAWINGS

Embodiments of the invention will now be described, by way of example only, with reference to the accompanying drawings in which:

FIG. 1 schematically illustrates a portable electronic device according to one embodiment.

FIG. 2 schematically illustrates an exemplary touch-screen display according to one embodiment.

FIG. 2A schematically illustrates an exemplary touch-screen display according to one embodiment.

FIG. 2B schematically illustrates an exemplary touch-screen display according to one embodiment.

FIG. 2C schematically illustrates an exemplary touch-screen display according to one embodiment.

FIG. 2D schematically illustrates an exemplary touch-screen display according to one embodiment.

FIG. 2E schematically illustrates an exemplary touch-screen display according to one embodiment.

FIG. 2F schematically illustrates an exemplary touch-screen display according to one embodiment.

FIG. 2G schematically illustrates an exemplary touch-screen display according to one embodiment.

FIG. 2H schematically illustrates an exemplary touch-screen display according to one embodiment.

FIG. 2I schematically illustrates an exemplary touch-screen display according to one embodiment.

FIG. 2J schematically illustrates an exemplary touch-screen display according to one embodiment.

FIG. 2K schematically illustrates an exemplary touch-screen display according to one embodiment.

FIG. 3 schematically illustrates a method according to one embodiment.

FIG. 3A schematically illustrates a method according to one embodiment.

FIG. 3B schematically illustrates a method according to one embodiment.

FIG. 3C schematically illustrates a method according to one embodiment.

FIG. 3D schematically illustrates a method according to one embodiment.

### DETAILED DESCRIPTION

Described herein are systems and methods for interfacing a user with a touch-screen. In overview, some embodiments provide for an array of conventional numerical keys to be graphically represented as a primary menu on a touch-screen of a cellular phone or PDA. The graphically represented keys are arranged as sectors or annular sectors in a contiguous array around a central origin or region. To provide text-based input (for example in the process of authoring a text-message or email), a user touch-selects one of the keys, and is provided with a secondary menu for allowing selection of a particular alphanumeric character associated with the selected numerical key. This association is optionally based on a protocol such as ETSI ETS 300 640 or ITU-T Recommendation E.161. In some embodiments the secondary menu, or a similar tertiary menu, is used to provide additional predictive text functionality.

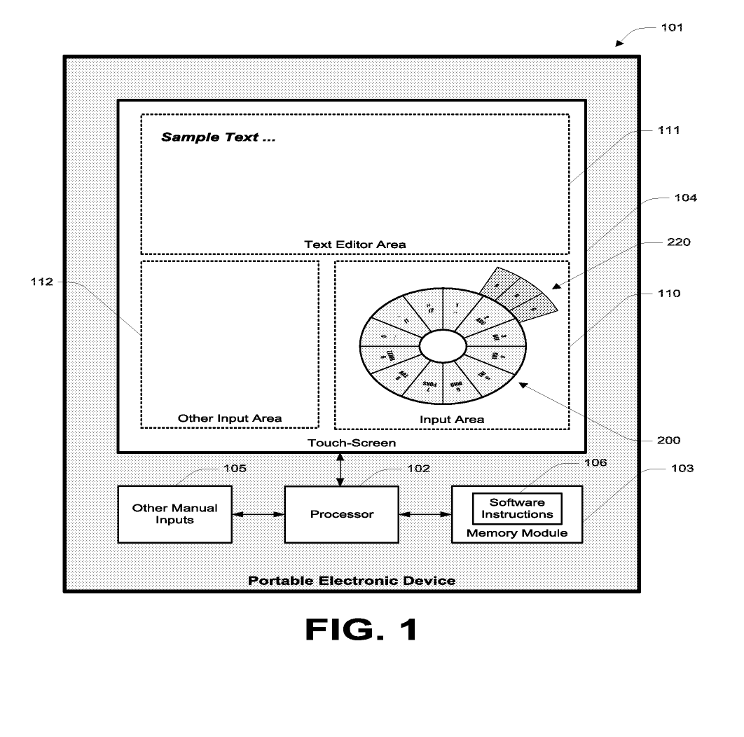

FIG. 1 schematically illustrates an exemplary portable electronic device 101 according to one embodiment. Device 101 includes a processor 102 coupled to a memory module 103 and a touch-screen 104. Processor 102 is also coupled to other manual inputs 105, such as physical buttons, and other not-shown components, which in some cases define or contribute to the purpose of device 101. For example, in one embodiment device 101 is an imaging phone, and the processor is additionally coupled to a GSM communications module and an imaging CCD.

Memory module 103 maintains software instructions 106 which, when executed on processor 102, allow device 101 to perform various methods and functionalities described herein. For example, on the basis of software instructions 106, device 101 performs methods for interfacing a user with a touch-screen or for displaying representations on a touch-screen. For example, on the basis of the software instructions, processor 102 causes graphical representations to be displayed on touch-screen 104, and is responsive to coordinate information indicative of touching of touch-screen 104.

The term “portable electronic device” as used herein should be read broadly. In the context of device 101, it refers to a generic device having components and functionalities described herein, without limitation to additional functionalities. Portable electronic devices present in various embodiments of the present invention include, but are not limited to:

Portable communications devices. That is, substantially any portable electronic device including a communications module, such as a GSM or CDMA module. Common examples include cellular phones, “smartphones” and so on.

### Portable computing devices, such as PDAs, Ultra Mobile Personal Computers (UMPCs), laptop computers, tablet computers, and thin-client remote controllers.

### Personal entertainment devices, such as gaming devices, media players (including audio and/or video players), imaging devices (such as digital still and/or video cameras) and the like.

It will be appreciated that many portable electronic devices fall into more than one of these categories.

The term “portable” should be read broadly to imply a degree of portability. In this way, “handheld” devices are considered to be a subset of “portable” devices. Furthermore, some embodiments are implemented in relation to non-portable devices, such as touch-screen information kiosks.

The term “touch-screen” should be read broadly to encompass any components or group of interrelated components that provide a display for displaying graphical representations and one or more sensors for identifying a location at which the display is touched. In some cases the sensors are responsive to pressure being exerted on a substrate (or pressure being exerted on a substrate and released), whereas in other cases the sensors are responsive to movement across a barrier overlying the screen, for example a barrier defined by one or more light paths. There is no strict requirement for the touch-screen to be responsive to direct touching of the display, and in some situations it may be responsive to touching or movement at a location functionally associated with the display, such as a proximal window or a separate touch pad. In some embodiments the touch-screen includes additional components, such as software and hardware.

The term “touching” should be read broadly to include substantially any manner for interacting with a “touch-screen”. This includes both physical contact with a substrate, and movement through a defined barrier (although this movement does not in all cases necessarily result in any physical touching of a substrate). That is, the system may be responsive to a “near touch”. In some embodiments the touching is effected by direct human touching (such as the use of a finger or thumb) or indirect human touching (for example by use of a stylus). Touching includes, in various embodiments, tapping and lifting on a region of the touch-screen, double tapping on a region of the touch-screen, or sliding and stopping on a region of the touch-screen.

As illustrated in FIG. 1, touch-screen 104 is schematically illustrated as a display screen for displaying graphical representations. Processor 102, on the basis of software instructions 106, instructs touch-screen 104 to display such representations. In some embodiments the display screen includes an LCD, plasma, CRT or other display. For the sake of the present disclosure, it is assumed that the display is pixel based. That is, the display includes an array of pixels that are actuated and/or colored under instruction of processor 102, thereby to provide the representations.

Some representations displayed on the touch-screen define input regions associated with respective commands. The processor is responsive to touching of the screen at a location overlying a given one of these input regions for performing a functionality corresponding to the relevant command. In particular, touching results in coordinate information being provided to processor 102, and processor 102 looks to match this coordinate information with information indicative of the representations on-screen at the time the coordinate information was generated, or the time at which the touching occurred, as well as with any associated commands.

In the example of FIG. 1, touch-screen 104 provides an input area 110, text editor area 111, and other input area 112. These areas are considered for the sake of explanation only, and should not be regarded as limiting in any way, particularly in relation to the relative sizes and positioning of these areas. For example, in some embodiments the input area defines substantially the whole screen. In other embodiments the input area is an overlay on the text editor area. The general intention of the present illustration is to show device 101 in an exemplary operational state where it is configured for authoring of a text-based message. In particular, a user interacts by way of touch with graphical representations shown in the input area to enter alphanumeric information that subsequently appears in the text editor area. The other input area provides associated commands, such as commands relating to the formatting and/or the delivery of text entered into the text editor area as an email or other text-based message.

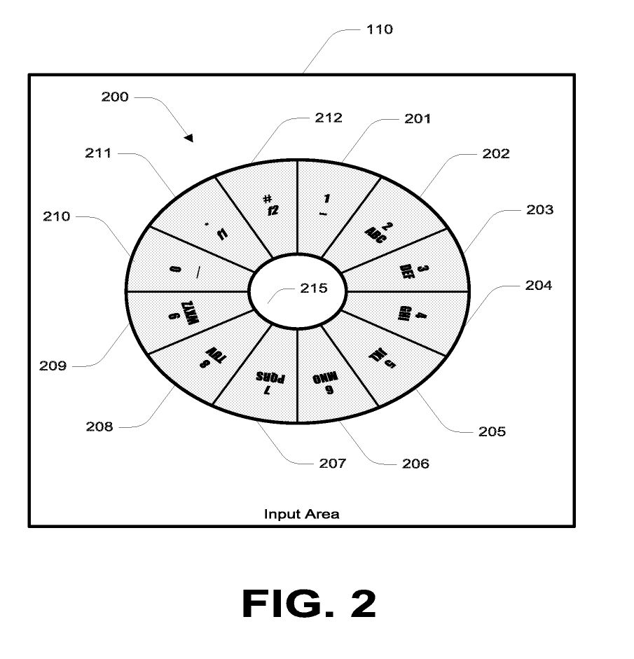

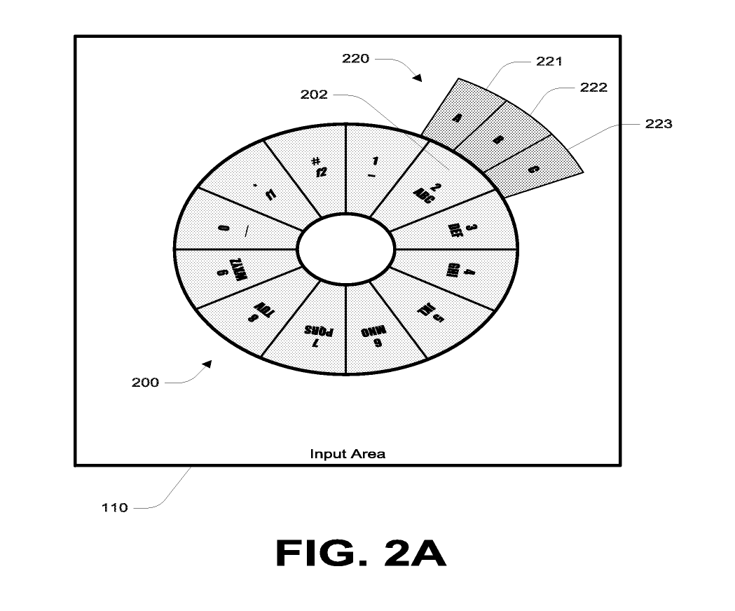

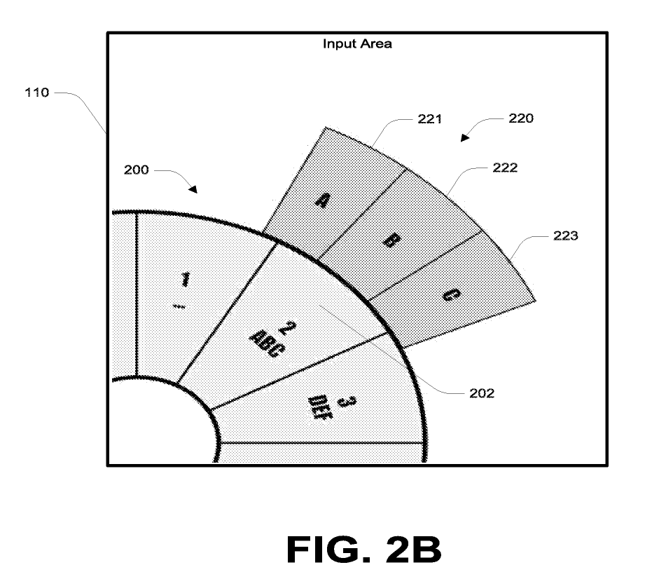

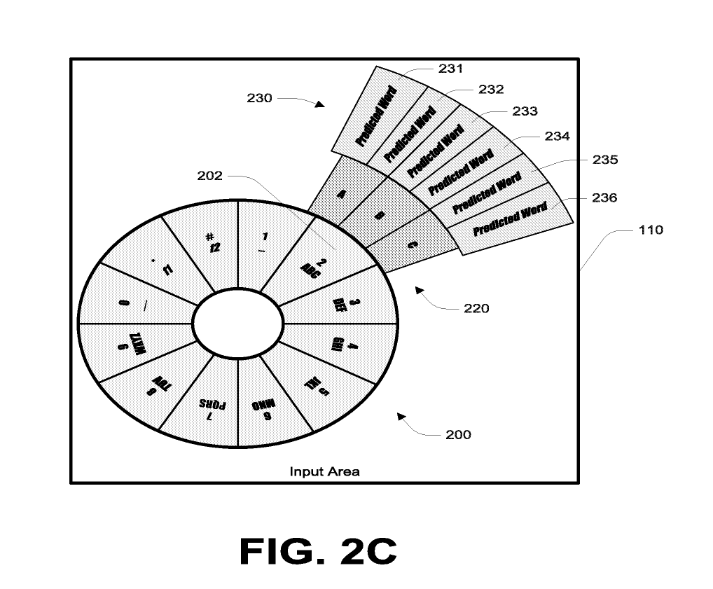

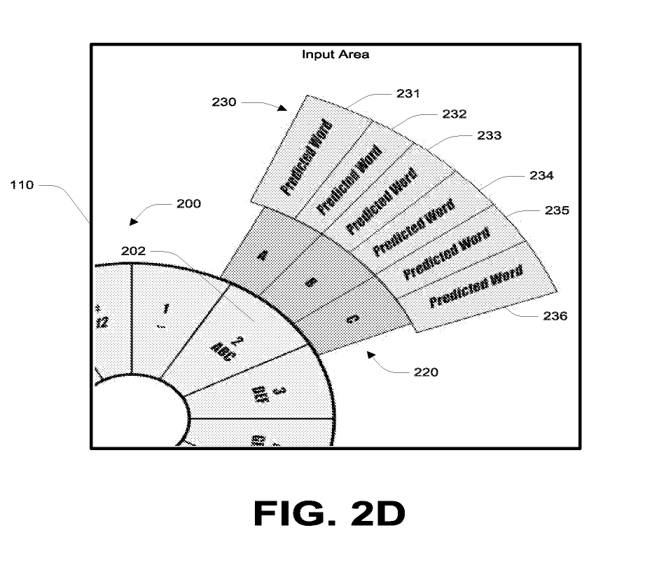

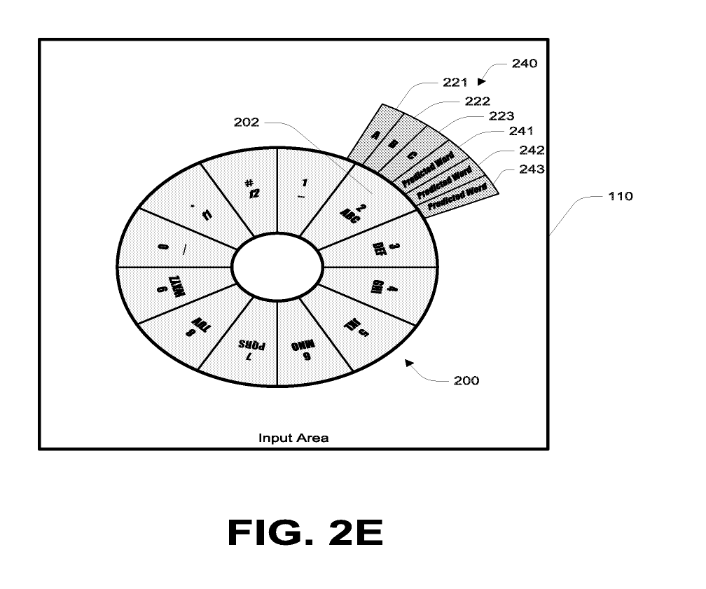

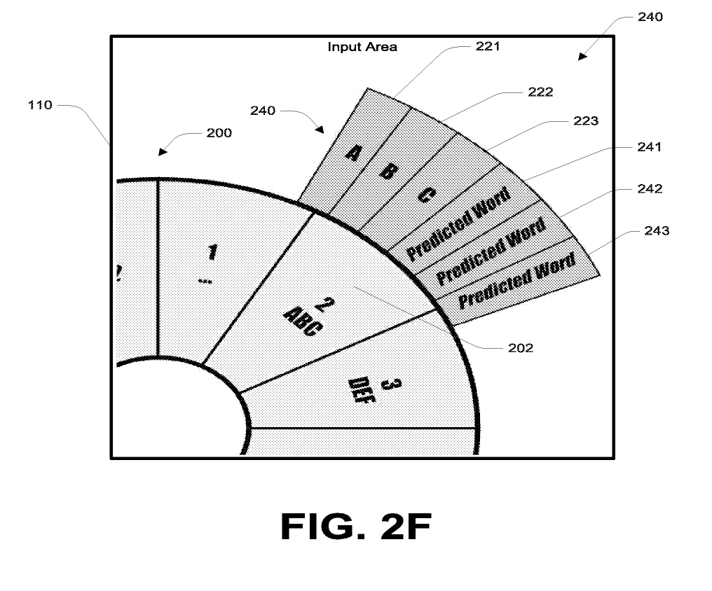

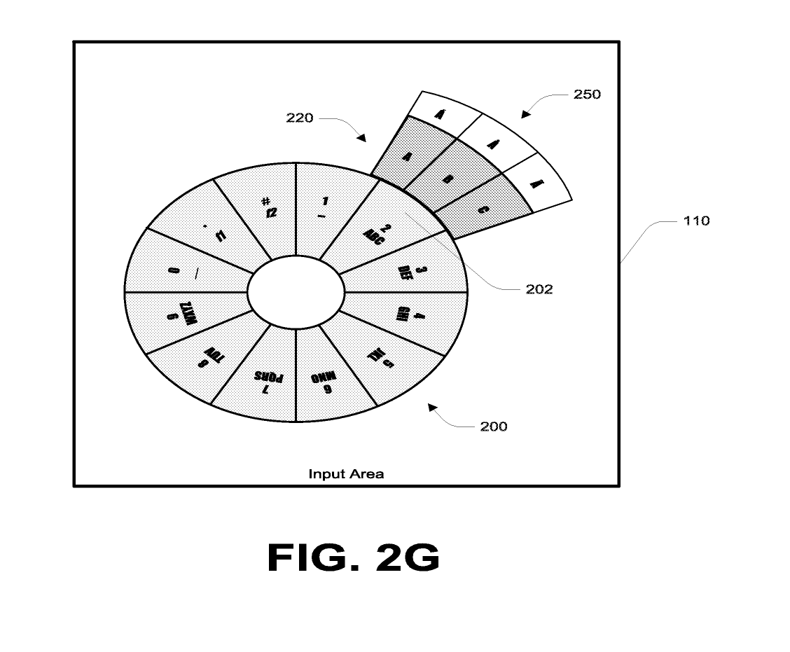

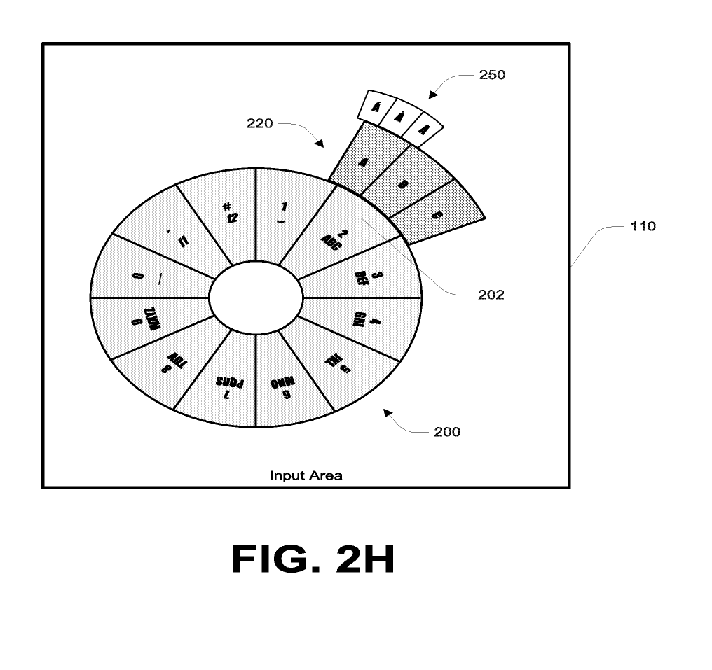

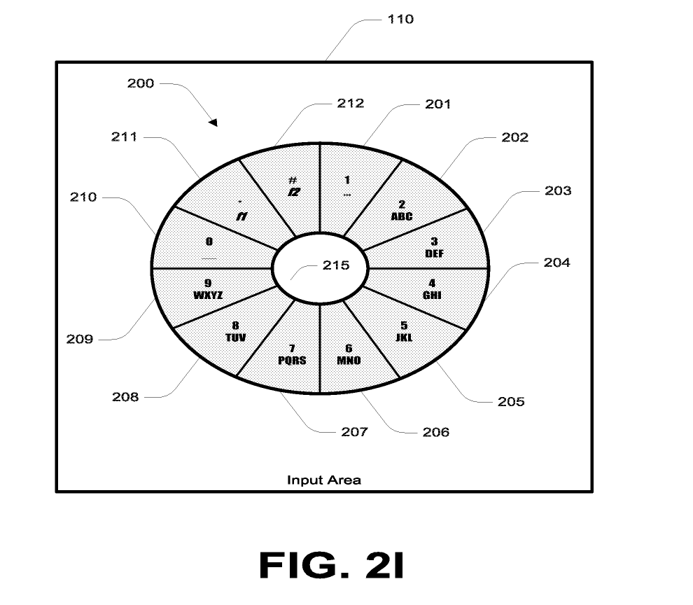

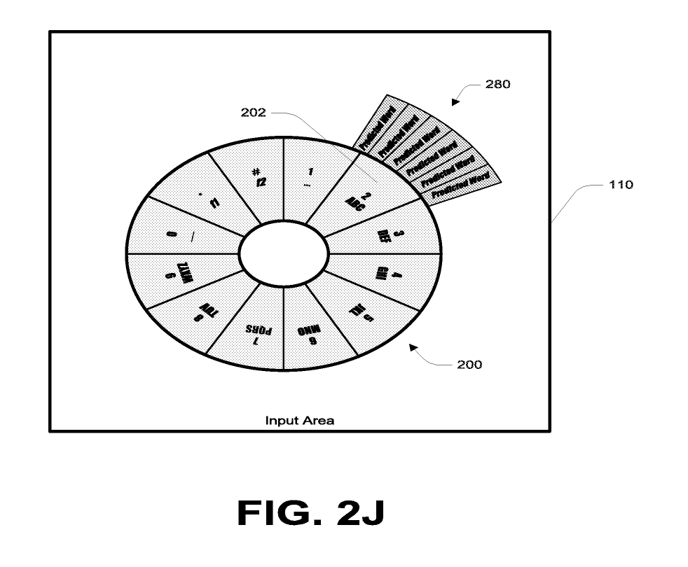

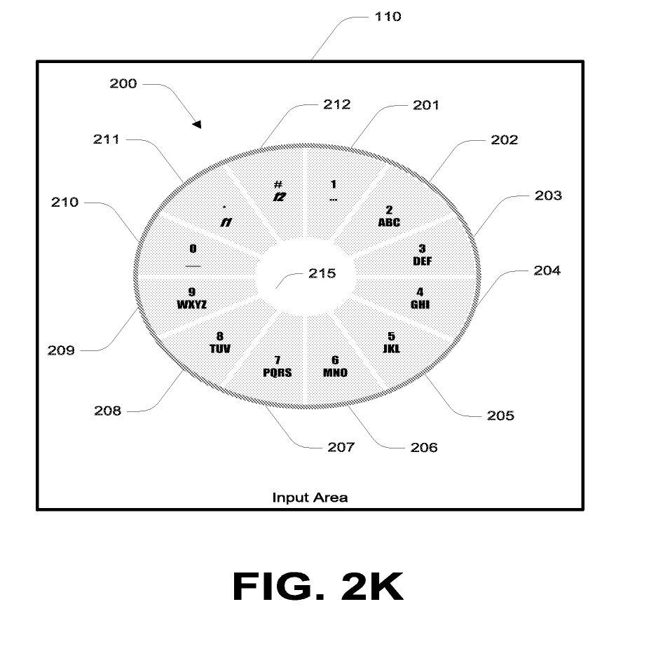

FIG. 2 through FIG. 2I show various exemplary representations displayable in input area 110. The general notion is that a user interacts with touch-screen 104 at input area 110 for inputting text-based data into text editor area 111. These representations are discussed in detail below.

FIG. 2 shows a representation including a circular primary menu 200. Menu 200 includes a plurality of primary input regions 201 to 212, corresponding to the twelve keys of a conventional telephone numerical keypad (numerals “0” to “9”, plus “*” and “#”). Input regions 201 to 212 are arranged as annular sectors in a contiguous array. Each input region is associated with a respective primary command, and displays a representation indicative of its respective primary command, for example a numeral and a selection of letters.

The manner in which the primary input regions are arranged should not be regarded as limiting. For example, in some embodiments the primary input regions corresponding to the numerals “0” to “9” are arranged other than in a sequential clockwise manner.

The term contiguous should be read broadly to cover situations where the input regions are spaced apart and therefore not directly adjacent one another. For example, in one embodiment radial neutral zones separate the input regions, these neutral zones having no associated command. The general intention is to create a barrier between input regions, and thereby reduce the risk of inadvertent selection of an unwanted input region. An example is provided in FIG. 2K.

In the example of FIG. 2, representations of letters and numbers are aligned about a circular path. However, in embodiments such as FIG. 2I, they are aligned in a more conventional manner.

In the present circumstances, the association of input regions and their primary commands is based on a protocol similar to ETSI ETS 300 640 or ITU-T Recommendation E.161. That is, each primary input region is intrinsically related to a numeral (or “*” or “#”), with the twenty-six letters of the Roman alphabet distributed amongst the input regions. That is, for a selection of the primary input regions, the representations shown are indicative of a plurality of distinct alphanumeric characters. In the illustrated embodiment, the “1”, “0”, “*” and “#” inputs are associated with special functions rather than letters, these specific functions optionally including symbols such as punctuation, currency or “smilies”, or character input modifiers such as “upper case”. In some embodiments these special functions are programmable to perform various other purposes.

By “programmable”, it is meant that the associated command is not fixed, and is variable at the discretion of a user. For example, a user is permitted to select the functionality of a given input region from a list of possible functionalities. In some embodiments input regions are programmable not only in terms of functionality, but also in terms of size, shape, location, and circumstances under which they are displayed on the screen. In some embodiments additional input regions are provided in area 110, and in some cases these are user-programmable to perform various functionalities not specifically considered herein.

In some embodiments there are additional or fewer primary input regions. For example, in some embodiments there are regions associated with punctuation commands, and in some embodiments “*” and “#” are omitted.

Although in the present embodiment, menu 200 is depicted as circular, in other embodiments alternate shapes may be used, such as shapes that are able to be defined by a contiguous array of sub-regions. Such shapes are considered to be “substantially circular”, and include polygons. In some embodiments a polygon is used having a number of sides equal to an integral fraction of the number of primary input regions. For example, a hexagon is conveniently used as an alternative in the example of FIG. 2. In some embodiments triangles or squares are used, or irregular shapes such as brand logos.

The term “annular sector” is used to describe a shape that has a first edge conformable to a substantially circular object (such as a circle or hexagon, in the case of the latter optionally spanning multiple sides of the hexagon such that the first edge includes a plurality of sides), a pair of sides extending from this first edge substantially along radial paths of the substantially circular object, and a second edge connecting the pair of sides at their respective ends distal from the first edge, this second edge being either straight, curved, or defined by a plurality of sides. In some embodiments, such as those illustrated, the second edge is a larger version of the first edge.

An annular sector has an “angular divergence”, defined as the angle at which the pair of sides diverge from one another. In the event that the sides are parallel, this angle is zero. Otherwise, the angular divergence is conveniently measurable by following the two sides towards a common converging origin, and measuring the angle at this origin.

In the present embodiment, primary input regions 201 to 212 are arranged as annular sectors around a central region 215. Central region 215 optionally defines an additional input region, such as a “shift” input, “space” input, “delete” input, or the like. In some embodiments it defines a plurality of input regions, for example half for “space” and half for “delete”. In still other embodiments it defines a “neutral zone” where a user can rest their finger without affecting any input. In some embodiments it performs a user-programmable functionality.

In some embodiments there is no central region, and as such primary input regions 201 to 212 are arranged as sectors rather than annular sectors. However, it will be appreciated that a central region provides distinct advantages, such as reducing the likelihood of a user inadvertently selecting an undesired input by touching close to the centre.

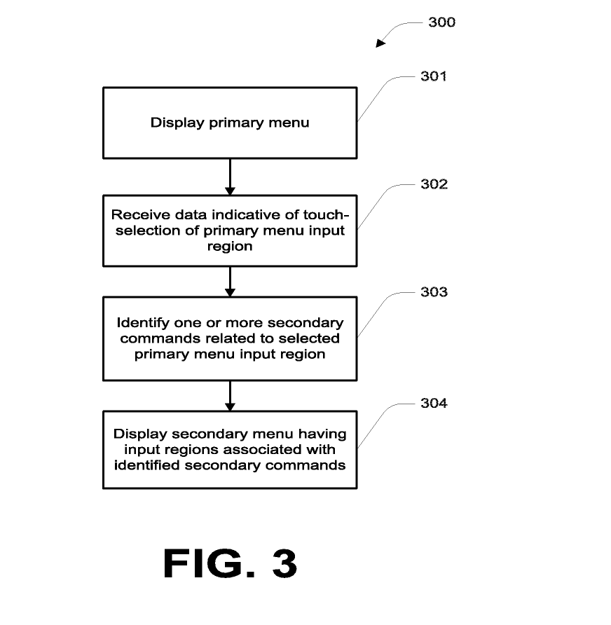

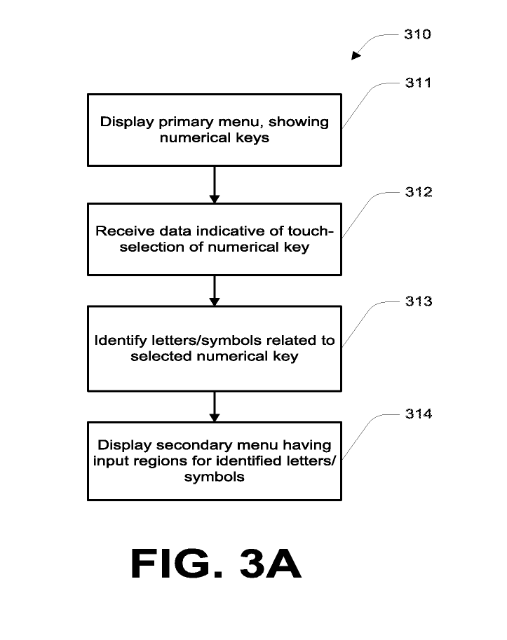

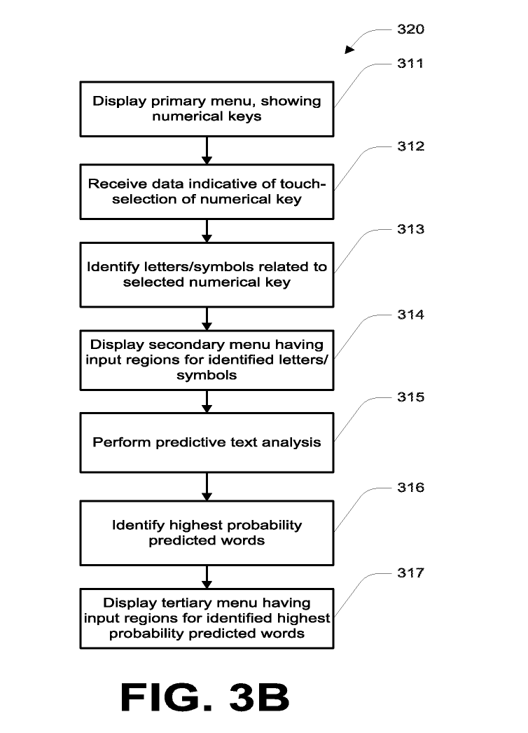

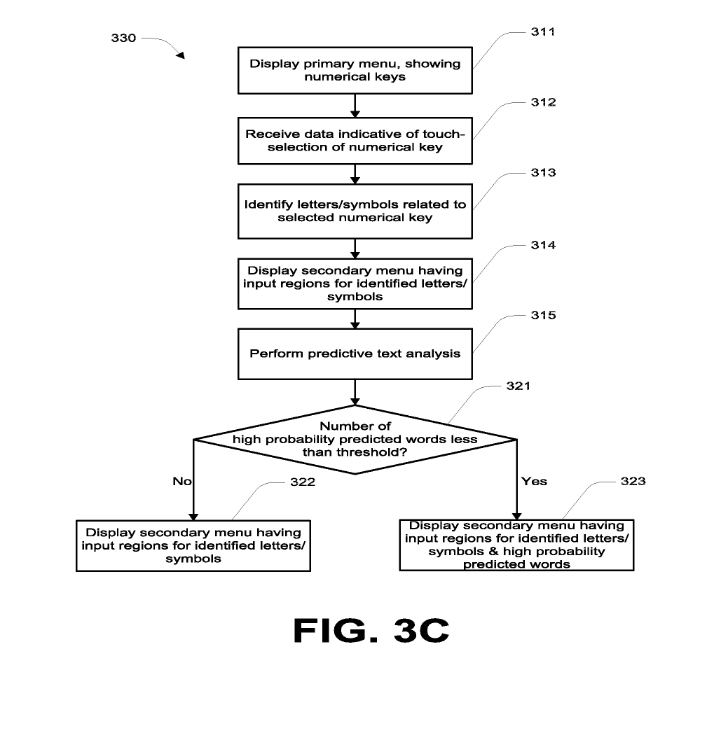

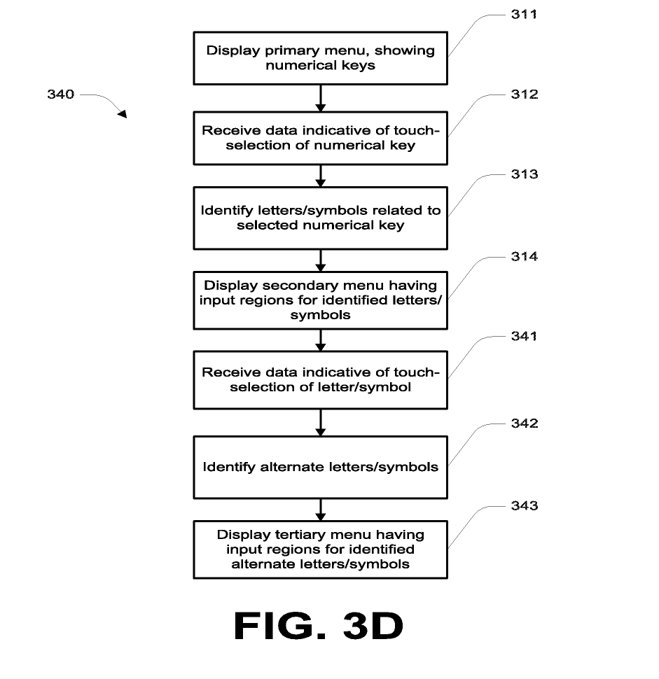

FIG. 2A shows a representation including a secondary menu 220. The secondary menu radially extends substantially as an annular sector from primary menu 200. In the illustrated embodiment, the secondary menu includes secondary input regions 221 to 223, respectively corresponding to the letters of which the adjacent primary input region is indicative. FIG. 3 and FIG. 3A illustrate exemplary methods for progressing between the representations of FIG. 2 and FIG. 2A. These are discussed below.

FIG. 3 shows a general method 300. Step 301 includes displaying a primary menu comprising one or more primary input regions, step 302 includes receiving data indicative of touch-selection of a primary input region, step 303 includes identifying one or more secondary commands related to the primary command associated with the selected primary input region, and step 304 includes displaying a secondary menu having input regions associated with identified secondary commands.

In the context of step 303, in some cases the primary command associated with the selected primary input region is indicative of one or more secondary commands or, in other cases, of an instruction to display a secondary menu representative of those one or more secondary commands. Often, the secondary menu is associable at a viewable level with the selected primary input region. For example, where the primary input region includes a group of representations, and the secondary menu includes secondary input regions each including a respective one of those representations.

FIG. 3A provides a more specific method 310, which relates to the example of FIG. 2. Step 311 includes displaying primary menu 200 comprising one or more primary input regions, step 312 includes receiving data indicative of a touch-selection of primary input region, essentially being a user-selection of one of the primary input regions, and step 313 again includes identifying one or more secondary commands related to the primary command associated with the selected primary input region. In this case, for a given primary input region, the associated input command is related to a plurality of secondary commands respectively corresponding to the distinct alphanumeric characters represented by the relevant primary input region, or alternate functions represented by the relevant primary input region. Secondary input regions displaying distinct characters are associated with a command to allow input of character commands for those characters. In the example illustrated in FIG. 2A, primary input region 202 representing “2”, “A”, “B” and “C” is touch-selected, and secondary menu 220 including secondary input regions 221, 222 and 223 associated with input commands for the letters “A”, “B” and “C” is displayed. In some embodiments, in the event that a user touch-selects one of these secondary input regions, the character associated with that region is “inputted”—for instance it appears in an editor field (such as text editor area 111).

To recapitulate, consider a scenario where a user wishes to input the letter “A”. The user first touch-selects primary input region 202, which opens secondary menu 220. The user then touch-selects secondary input region 221 to input the letter “A”. The secondary menu is then closed, such that only the primary menu 200 is shown, allowing for another character to be inputted.

In some embodiments text editor area 111 allows a previously inputted word or character to be selected by touching that word or character. In one embodiment, touch-interaction allows a user to manipulate a cursor in the text editor area. For example, the user taps at a location within text editor area 111 to place the cursor at that location, or double-taps on an existing word to select that word. Input area 10 is then used to input text and/or make modifications to existing text.

In various embodiments the secondary menu is closed responsive to either or both of the inputting of a character or the touch-selection of a different primary input region.

In some embodiments secondary menu 220 includes an additional secondary input region for a numeral associated with the relevant primary input region (“2” in the case of primary input region 202). However, in the illustrated embodiment, upon the display of secondary menu 220, the causal primary input region becomes associated with a command to input that numeral. As such, in the context of FIG. 2A, a user touches primary input region 202 twice to enter the numeral “2”.

In the illustrated embodiment, the secondary menu 220 shares a common origin with the primary menu 200. That is, the sides of the secondary menu effectively diverge from an origin at the centre of the primary menu.

From a usability perspective, there are distinct advantages stemming from the positioning and configuration of secondary menus with respect to primary input regions. Firstly, the secondary menu radially extends from a location adjacent and centered on the primary input region which, when selected, results in the display of that secondary menu. As such, the secondary input regions are located proximal the location of the most recent touch-selection. Additionally, the secondary menu preferably has an angular divergence of between 50% and 200% of the angular divergence of the touch-selected primary input region, or more preferably between 100% and 150% of the angular divergence of the touch-selected primary input region. In some embodiments the secondary menu has an angular divergence approximately equal to the angular divergence of the touch-selected primary input region. These angular divergence selections make it particularly convenient for a user to quickly touch-select a secondary input region following touch-selection of a primary input region. This is far more convenient than in cases where a secondary menu spans too great a portion of the primary menu's periphery, for example where the secondary menu is annular. Advantages associated with the presently proposed approach should be apparent from the provided illustrations.

In some embodiments, rather than considering a variation between the angular divergence of the primary input region and the secondary menu, the approach is to consider a variation between the angular divergence of the primary input region and angular divergence of a hypothetical annular sector sharing a common origin with the primary menu and meeting the periphery of the primary menu at the same locations as the secondary menu. It will be appreciated that this is an equivalent approach.

In some embodiments, upon the secondary menu being displayed, the on-screen positioning of the primary and secondary menus varies in relation to a predefined origin. For example, where these menus share a common origin, that origin is shifted along a vector defined by a central radius of the touch-selected primary input region, in a direction towards the origin of the primary menu so as to present the secondary menu at a more central region of area 110. In some embodiments this shifting essentially moves a portion of the primary menu to an off-screen location. In other words, a portion of the primary menu is not rendered on-screen for a period of time while the secondary menu is displayed. In some embodiments the shifting is displayed by way of an animation at a rate of between two and thirty frames per second.

As shown in FIG. 2B, in some cases the on-screen positioning of the primary and secondary menus varies in terms of both location and scale. In this example, the scale is increased so as to provide a user with a larger (and therefore easier to see) secondary menu.

In the present embodiment, upon selection of a secondary input, the secondary menu closes and the input area returns to the configuration shown in FIG. 2 so that a further primary input can be selected.

In some embodiments predictive text functionalities are provided. One example is shown in FIG. 2C, where a tertiary menu 230 radially extends from secondary menu 220, this tertiary menu including tertiary input regions 231 to 236 each being associated with an input command for a word identified by a predictive text protocol. Representations of the words themselves are graphically displayed in the tertiary input regions, and a user either touch-selects one of the tertiary input regions to input a word, or a secondary input region to input a single character.

In some embodiments, such as that of FIG. 2D, a scale/location variation is applied to make the tertiary menu 230 easier to view.

FIG. 3B illustrates a method 320 for displaying a tertiary menu according to one embodiment. The method commences with steps 311 to 314 described above. Step 315 includes performing a predictive text analysis for identifying one or more predicted words, for example using the “T9” protocol. For example, previous inputs defining a partial word are analyzed to determine one or more complete words formable on the basis of the existing partial word and characters corresponding to the most recently selected primary input region.

Step 316 includes identifying the highest probability predicted words. In the present embodiment, words are hierarchically identified in accordance with the perceived likelihood of desirability, for example using a look-up table that is either permanent or updatable based on historical usage. Generally there will be a limit to the number of tertiary input regions containable in a tertiary menu, for example based on text size and angular divergence constraints. In such a case, only a selection of the total list of possible words is identified, the selection including the highest probability predicted words (those predicted words having the highest perceived likelihood of desirability). Step 317 includes displaying a tertiary menu, such as tertiary menu 230, having tertiary input regions for these identified highest probability predicted words.

It will be appreciated that the present approach provides a significant advantage over prior art approaches in that a plurality of predicted words are simultaneously displayable. In many prior art approaches, a user is required to scroll through a sequential list of predicted words to identify the desired one (or none).

FIG. 2E shows another example of predictive text input. In this example, predicted words are provided alongside individual characters in a secondary menu 240. This secondary menu includes character inputs 221 to 223, plus predicted word inputs 241 to 243. As with the example considered above, predicted words are identified by way of a predictive text protocol. A user is permitted to touch-select one of the predicted word input regions to input the relevant word, or one of the character input regions to input a single character.

Similarly to the example considered above, in some embodiments, such as that of FIG. 2F, a scale/positioning variation is applied to make the secondary menu 240 easier to view.

The number of predicted word inputs for an embodiment such as FIG. 2E varies between instances. For example, in the interests of menu clarity, the number of predicted word inputs is limited to between zero and five, with only the highest probability predicted words being assigned predicted word input regions.

FIG. 3C shows an exemplary method 330 for administering predictive text in a secondary menu, the method commencing with steps 311 to 315 described above. Step 321 then includes determining whether the number of high-probability predicted words is less than (or equal to) a predetermined threshold. In the present embodiment, each identified predicted word is provided a probability rating that identifies the perceived likelihood of that word being desired by the user. Only identified words having a probability rating greater than a certain threshold are considered for secondary menu inclusion. Furthermore, predicted word inputs are only displayed in a secondary menu in the event that a relatively small threshold number of high-probability predicted words are identified, this threshold number being, in various embodiments, between one and five. In the present embodiment, the threshold number is three. In the event that the number of high probability predicted words is greater than the threshold, the method progresses to step 322 where a secondary menu is displayed having input regions for identified letters/symbols only. Otherwise, the method progresses to step 323, where a secondary menu is displayed having input regions for identified letters/symbols as well as the high probability predicted words.

In some embodiments predicted words are displayable in both secondary and tertiary menus, for example by combining methods 320 and 330. In a further embodiment, shown in FIG. 2J, only predicted words are provided in a secondary menu 280.

It will be appreciated that the detailed operation of various embodiments is somewhat dependent on the predictive text protocol used. Various modifications are able to be made in light of strengths and/or weaknesses of different predictive text protocols, such modifications falling within the scope of the present invention.

In some embodiments, the input regions of a tertiary menu are selected in response to the touch-selection of a secondary input region. For example, following touch-selection of one of the secondary input regions, one or more tertiary commands related to the secondary command associated with the touch-selected secondary input region are, in some embodiments, identified and subsequently displayed on the screen in a tertiary menu including one or more tertiary input regions respectively associated with the one or more tertiary commands. An example of this approach is provided by method 340 of FIG. 3D, which is described below by reference to the screen display of FIG. 2G.

FIG. 2G provides an example of where a tertiary menu is provided to allow convenient selection of alternate letters/symbols, such as language-specific letters like it, ü, ä, ö. In overview, a user touch-selects a character in a secondary menu and, in the event that there are alternate letters/symbols related to that letter (in a database or other information repository), a tertiary menu 250 is provided for the alternate letters/symbols. In the present example, these alternate letters/symbols are not graphically represented in the secondary menu. The user optionally either touches one of the alternate letters/symbols to input that alternate letter/symbol, or touch-selects the character in the secondary menu once again to input that character. The secondary and tertiary menus close following input. FIG. 2H shows a similar embodiment wherein tertiary menu 250 is centered on the relevant secondary input region.

Method 340 includes steps 311 to 314 described above. Step 341 then includes receiving data indicative of touch-selection of a letter/symbol in a secondary menu, step 342 includes identifying alternate letters/symbols related to the touch-selected letter/symbol, and step 343 includes displaying a tertiary menu having input regions for the identified alternate letters/symbols.

In some embodiments, the primary menu is used without secondary or tertiary menus. For example, in one embodiment the touch-screen displays a primary menu as discussed previously, this menu including a set of primary input regions that correspond to keys on a 12-key telephone keypad. This primary menu is used to allow convenient user input of text-based data in accordance with a predictive text protocol, such as T9. For example, the user touch-selects one of the primary input regions, and the supporting processor identifies one or more characters related to the selected input region. The processor subsequently provides a data packet indicative of the one or more characters to a predictive text module.

In one embodiment, the predictive text module looks for predicted words formable by one or more of these data packets as sequentially arranged. In the case that a given data packet defines the commencement of a word, the predictive text module identifies none or more predicted words formable from the one or more characters of the data packet. Otherwise, if a word has already been commenced by previous inputs (that is, the data packet in question defines a portion of a previously commenced word defined by one or more preceding data packets, these preceding data packets also each being indicative of a respective one of more characters), the predictive text module identifies none or more predicted words formable from the one or more characters of the present data packet in combination with the respective one or more characters of the one or more preceding data packets.

As foreshadowed, other predictive text approached are used in alternate embodiments.

The user is allowed, for example by options presented via the touch screen, to select between identified predicted words (assuming one or more were identified). In some embodiments the selection of a word is achieved via the primary menu, whilst in other embodiments it is achieved by other means, such as options provided within the text editor region or elsewhere. If the user selects one of these predicted words, that word is inputted in the text editor region. Alternately, the user is permitted to touch select another primary input region (which may be the same as the one previously selected) to continue authoring the present word.

Although the embodiments considered herein have been predominantly described by reference to the Roman alphabet, it will be appreciated that other embodiments are able to be implemented for handling Asian language characters (be they alphabetic or pictographic), or other non-Roman characters. Those with an understanding of such languages will readily adapt the general structural framework described herein to those languages. For example, in some embodiments the primary input regions provide building blocks for the creation of more complex characters or symbols.

It will be appreciated that the above disclosure provides various systems and methods for interfacing a user with a touch-screen, these methods and systems providing distinct advantages and technical contributions over what was previously known in the art.

Unless specifically stated otherwise, as apparent from the following discussions, it is appreciated that throughout the specification discussions utilizing terms such as “processing”, “computing”, “calculating”, “determining”, “analyzing” or the like, refer to the action and/or processes of a computer or computing system, or similar electronic computing device, that manipulate and/or transform data represented as physical (e.g. electronic), quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a central processing unit (CPU), a graphics processing unit, and a programmable DSP unit. The processing system further may include a memory subsystem including main RAM and/or a static RAM, and/or a dynamic RAM, and/or ROM. A bus subsystem may be included for communicating between the components. The processing system further may be a distributed processing system with processors coupled by a network. If the processing system requires a display, such a display may be included, e.g., an liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier media carrying computer-readable code.

Furthermore, a computer-readable carrier medium may form, or be included, in a computer program product.

In alternative embodiments, the one or more processors operate as a standalone device or may be connected, e.g., networked to other processor(s), in a networked deployment. The one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagrams only show a single processor and a single memory that carries the computer-readable code, those in the art will understand that many of the components described above are included, but not explicitly shown or described in order not to obscure the inventive aspect. For example, while only a single machine is illustrated, the term “machine” or “device” shall also be taken to include any collection of machines that individually or jointly execute a set (or multiple sets) of instructions to perform any one or more of the methodologies discussed herein.

At least one embodiment of each of the methods described herein is in the form of a computer-readable carrier medium carrying a set of instructions, e.g., a computer program, that are for execution on one or more processors, e.g., one or more processors that are part of a building management system. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of a carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media include, for example, optical, magnetic, and magneto-optical disks. Volatile media include dynamic memory, such as main memory. Transmission media include coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to include, but not be limited to, solid-state memories, a computer product embodied in optical or magnetic media, a medium bearing a propagated signal detectable by at least one processor of one or more processors and representing a set of instructions that when executed implement a method, a carrier wave bearing a propagated signal detectable by at least one processor of the one or more processors and representing a set of instructions that when executed implement a method, and a transmission medium in a network bearing a propagated signal detectable by at least one processor of the one or more processors and representing a set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms “comprising”, “comprised of” or “which comprises” is an open term that means including at least the elements/features that follow, but not excluding others. Thus, the term “comprising”, when used in the claims, should not be interpreted as being limitative to the means or elements or steps listed thereafter. For example, the scope of the expression “a device comprising A and B” should not be limited to devices consisting only of elements A and B. Any one of the terms “including” or “which includes” or “that includes” as used herein is also an open term that also means including at least the elements/features that follow the term, but not excluding others. Thus, “including” is synonymous with and means “comprising”.

Similarly, it is to be noted that the term “coupled”, when used in the claims, should not be interpreted as being limitative to direct connections only. Where the terms “coupled” or “connected”, along with their derivatives, are used, it should be understood that these terms are not intended as synonyms for each other. Thus, the scope of the expression “a device A coupled to a device B” should not be limited to devices or systems wherein an output of device A is directly connected to an input of device B. Rather, it means that there exists a path between an output of A and an input of B which may be a path including other devices or means. “Coupled” may mean that two or more elements are either in direct physical or remote (e.g. optical or wireless) contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the appended claims. For example, any formulas given above are merely representative of procedures that may be used. Functionality may be added or deleted from the block diagrams, and operations may be interchanged among functional blocks. Steps may be added or deleted to methods described within the scope of the present invention.

1. A method for interfacing a user with a touch-screen, the method including the steps of:
(a) displaying on the touch-screen a representation of a substantially circular primary menu, the primary menu including a plurality of primary input regions arranged as sectors or annular sectors in a contiguous array, each primary input region being associated with a respective primary command, each primary input region displaying a representation indicative of its respective primary command;
(b) being responsive to a touch-selection of one of the primary input regions for identifying one or more secondary commands related to the primary command associated with the touch-selected primary input region;
(c) displaying on the touch-screen a representation of a secondary menu, the secondary menu radially extending substantially as an annular sector from the periphery of the primary menu substantially adjacent the touch-selected primary input region, the secondary menu including one or more secondary input regions, the one or more secondary input regions being respectively associated with the one or more secondary commands, each secondary input region displaying a representation indicative of its respective secondary command.

2. A method according to claim 1 wherein, for at least one primary input region, the representation is indicative of a plurality of distinct alphanumeric characters.

3. A method according to claim 2 wherein, for the at least one primary input region, the associated primary command is related to a plurality of secondary commands respectively corresponding to at least one of the distinct alphanumeric characters.

4. A method according to claim 3 wherein the relationship between primary and secondary commands is affected by the operation of a predictive text protocol, such that for the at least one primary input region, the associated primary command is relatable to a plurality of secondary commands respectively corresponding to predicted words.

5. A method according to claim 1 wherein the secondary menu shares a common origin with the primary menu.

6. A method according to claim 1 wherein the secondary menu has an angular divergence of between 50% and 200% of an angular divergence of the touch-selected primary input region.

7. A method according to claim 1 wherein the secondary menu has an angular divergence of between 100% and 150% of an angular divergence of the touch-selected primary input region.

8. A method according to claim 1 wherein the secondary menu has an angular divergence approximately equal to an angular divergence of the touch-selected primary input region.

9. A method according to claim 1 wherein, upon the secondary menu being displayed, the on-screen positioning of the primary and secondary menus varies.

10. A method according to claim 9 wherein the variation includes movement substantially along a vector defined by a central radius of the touch-selected primary input region having a direction towards an origin of the primary menu.

11. A method according to claim 1 wherein, upon the secondary menu being displayed, the on-screen scaling of the primary and secondary menus varies.

12. A method according to claim 1 wherein the primary input regions correspond to keys on a twelve-key telephone keypad.

13. A method according to claim 1 including the further steps of:
(d) being responsive to a touch-selection of one of the secondary input regions for inputting a character, symbol or word represented by that secondary input region;
(e) following step (d), closing the secondary menu.

14. A method according to claim 1 including the further steps of:
(f) being responsive to a touch-selection of one of the secondary input regions for identifying one or more tertiary commands related to the secondary command associated with the touch-selected secondary input region;
(g) displaying on the screen a representation of a tertiary menu, the tertiary menu radially extending substantially as an annular sector from the periphery of the secondary menu substantially adjacent the touch-selected secondary input region, the tertiary menu including one or more tertiary input regions, the one or more tertiary input regions being respectively associated with the one or more tertiary commands, each tertiary input region displaying a representation indicative of its respective tertiary command.

15. A method according to claim 14 including the steps of:
(h) being responsive to a touch-selection of one of the tertiary input regions for inputting a character, symbol or word represented by that tertiary input region;
(i) following step (h), closing the tertiary and secondary menus.

16. A method according to claim 1 including the steps of:
(j) being responsive to touch selection of a primary input region for identifying one or more predicted words on the basis of a predictive text protocol;
(k) providing in the secondary menu one or more secondary input regions each having an associated secondary command indicative of one of the predicted words, and displaying a representation indicative of that predicted word.

17. A method according to claim 16 including the steps of:
(l) being responsive to a touch-selection of one of the secondary input regions having an associated secondary command indicative of a predicted word for inputting that predicted word;
(m) following step (l), closing the secondary menu.

18. A method according to claim 1 including the steps of:
(n) being responsive to touch selection of a primary input region for identifying one or more predicted words on the basis of a predictive text protocol;
(o) displaying on the screen a representation of a tertiary menu, the tertiary menu radially extending substantially as an annular sector from the periphery of the secondary menu displayed at step (c), the tertiary menu including one or more tertiary input regions, the one or more tertiary input regions being respectively associated with one or more tertiary commands each respectively indicative of a predicted word, each tertiary input region displaying a representation indicative of its respective predicted word.

19. A method according to claim 18 including the steps of:
(p) being responsive to a touch-selection of one of the tertiary input regions having an associated tertiary command indicative of a predicted word for inputting that predicted word;
(q) following step (p), closing the tertiary and secondary menus.

20. A method for interfacing a user with a touch-screen, the method including the steps of:
(a) displaying on the touch-screen a representation of a substantially circular primary menu, the primary menu including a plurality of primary input regions arranged as sectors or annular sectors in a contiguous array, the primary input regions including a set of primary input regions that correspond to one or more keys on a 12-key telephone keypad;
(b) being responsive to a touch-selection of one of the primary input regions for identifying one or more characters related to the touch-selected primary input region;
(c) displaying on the touch-screen a representation of a secondary menu, the secondary menu radially extending substantially as an annular sector from the periphery of the primary menu substantially adjacent the touch-selected primary input region, the secondary menu including one or more secondary input regions, the one or more secondary input regions corresponding to the one or more characters related to the touch-selected primary input region.

21. A method according to claim 20 including the steps of:
(d) being responsive to a touch-selection of one of the secondary input regions for inputting a character, symbol or word represented by that secondary input region;
(e) following step (d), closing the secondary menu.

22. A method according to claim 20 wherein the primary input regions are defined by the set of primary input regions that corresponds to the keys on a 12-key telephone keypad.

23. A computer-readable carrier medium carrying a set of instructions that when executed by one or more processors cause the one or more processors to carry out a method according to any one claim 1.

24. A device including:
a touch-screen; and
a processor coupled to the touch-screen for carrying out a method according to claim 1.

25. A method for interfacing a user with a touch-screen, the method including the steps of:
(a) displaying on the touch-screen a representation of a substantially circular primary menu, the primary menu including a plurality of primary input regions arranged as sectors or annular sectors in a contiguous array, the primary input regions including a set of primary input regions that correspond to keys on a 12-key telephone keypad;
(b) being responsive to a touch-selection of one of the primary input regions for identifying one or more characters related to the touch-selected primary input region;
(c) providing a data packet indicative of the one or more characters to a predictive text module for:
i. in the case that the data packet defines the commencement of a word, identifying none or more predicted words formable from the one or more characters of the data packet;
ii. in the case that the data packet defines a portion of a previously commenced word defined by one or more preceding data packets, the preceding data packets each being indicative of a respective one of more characters, identifying none or more predicted words formable from the one or more characters of the data packet in combination with the respective one or more characters of the one or more preceding data packets;
(d) allowing a user to select between the none or more identified predicted words or touch-select another of the primary input regions;
(e) being responsive to a user-selection of one of the predicted words for providing an instruction to input the selected predicted word.
